(19) United States
(12) Patent Application Publication
(10) Pub. No.: US 2008/0090612 A1
(43) Pub. Date: Apr. 17, 2008

(54) METHOD OF AUTHENTICATING DEVICES FOR COMMUNICATION OVER SHORT RANGE AIR INTERFACES

(76) Inventor: Michael F. Glinka, Nuremberg (DE)

Correspondence Address: MARK W. SINCELL;Williams, Morgan & Amerson, P.C., Suite 1100, 10333 Richmond, Houston, TX, 77042, US

(21) Appl. No.: 11/549,716

(22) Filed: Oct. 16, 2006

(51) Int. Cl. H04B 1/38

(52) U.S. Cl. 455/557

(57) ABSTRACT

The present invention provides methods involving a first device, at least one second device, and a core network in a wireless communication system. One embodiment of the method includes establishing a first secure wireless connection over a first air interface between the first device and the at least one second device based on security information received from the core network using a second secure wireless connection over a second air interface.

### BACKGROUND OF THE INVENTION

1. Field of the Invention

This invention relates generally to communication systems, and, more particularly, to wireless communication systems.

2. Description of the Related Art

Short-range air interfaces have been developed to support communication between devices that typically remain relatively close to each other. The Bluetooth short-range air interface supports wireless communication between devices that are separated by a distance of up to approximately 100 meters. For example, Bluetooth supports at least three different classes of communication that are distinguished based on the transmission power and device separation: class 3 supports a transmission power of about 1 milliwatt for distances of up to about 3.3 feet (1 meter), class 2 supports a transmission power of about 10 milliwatts for distances of up to about 33 feet (10 meters), and class 1 supports a transmission power of about 100 milliwatts for distance of up to about 328 feet (100 meters). Bluetooth has been implemented in a wide variety of devices including keyboards, computer mice, headphones, earpieces, and other peripheral devices, as well as cellular telephones, smart phones, personal data assistants, notebook computers, desktop computers, and the like.

Short-range air interfaces have a number of advantages over long-range air interfaces such as radiofrequency air interfaces used for cellular voice and/or data communication. For example, the transmitters typically require substantially less power and the receivers may be less sensitive than the corresponding devices used for long-range air interfaces. However, short-range air interfaces also have a number of drawbacks, as will be discussed below.

Signals transmitted over short-range air interfaces may be intercepted by any device that is within range of the transmitting device. Consequently, devices that use short-range air interfaces may be vulnerable to attacks that utilize the information transmitted over the air interface. For example, an attacker may acquire sensitive information (e.g., passwords, security keys, confidential, personal, and/or proprietary information, and the like) from a nearby device by eavesdropping on transmissions over the short-range air interface by the nearby device. Although the limited range of the transmissions over the short-range air interface (e.g., approximately 10 m for a Bluetooth interface) may reduce the number of potential attackers, devices that are operated in heavily trafficked areas such as airports may remain vulnerable to such attacks. Furthermore, attackers may use range extenders to monitor or eavesdrop on short-range transmissions from a much greater distance than the nominal range of the short-range air interface.

FIG. 1 conceptually illustrates a conventional technique for mutually authenticating two Bluetooth devices over a short-range Bluetooth radio interface. Short-range air interfaces, such as Bluetooth, implement security systems based on secret personal identification numbers (PINs). For example, a first Bluetooth device initially acts as the claimant and provides its address to the second Bluetooth device (i.e., the verifier device), which generates a random number and provides the random number to the claimant over the radio interface. The first and second Bluetooth devices use the address, the random number, and a link key to compute a result (SRES) using a cryptographic function. The verifier then compares its result to the result computed by the claimant and provided to the verifier over the radio interface. If the two results are the same, then the claimant is authenticated to the verifier. The first and second Bluetooth devices may then switch roles (i.e., the claimant becomes the verifier and vice versa) and repeat the authentication process to mutually authenticate the two Bluetooth devices.

Systems that implement short-range air interfaces, such as the Bluetooth interface, may nevertheless remain vulnerable to attackers. For example, the security of a Bluetooth system relies on the user's choice of a secret Personal Identification Number (PIN), which is often much too short. Shaked and Wool (“Cracking the Bluetooth PIN” Proc. 3rd USENIX/ACM Conf. Mobile Systems, Applications, and Services (MobiSys), pages 39-50, Seattle, Wash., June 2005) have demonstrated that conventional four-digit PINs implemented in Bluetooth can be cracked in less than 0.3 seconds on an old Pentium III 450 MHz computer and in approximately 0.06 seconds on a Pentium IV 3 GHz HT computer. Shaked and Wool demonstrated further that even if pairing of two Bluetooth devices has already been done, it is even possible to re-initiate the pairing process by transmitting a ‘forget-message’ from a masqueraded device. The ‘forget-message’ can be transmitted after having spoofed the device's personal ID, which is broadcast to all Bluetooth devices.

Moreover, the Bluetooth designers invented several new cryptographic primitives and incorporated the new primitives into the system. Cryptographers consider fielding new primitives to be risky, because new cryptography is less tested and may contain hidden flaws. Furthermore, as Bluetooth gains popularity on personal data assistants and laptops, attackers may have more incentive to attack the Bluetooth interface as the information transmitted over the Bluetooth interface grows from cell-phone address books to valuable corporate data.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, methods involving a first device, at least one second device, and a core network in a wireless communication system are provided. One embodiment of the method includes establishing a first secure wireless connection over a first air interface between the first device and the at least one second device based on security information received from the core network using a second secure wireless connection over a second air interface. Another embodiment of the method includes providing security information to the first device. The security information is usable by the first device to establish a first secure wireless connection over a first air interface between the first device and at least one second device. The security information is provided using a second secure wireless connection over a second air interface.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a conventional technique for mutually authenticating two Bluetooth devices over a short-range Bluetooth radio interface;

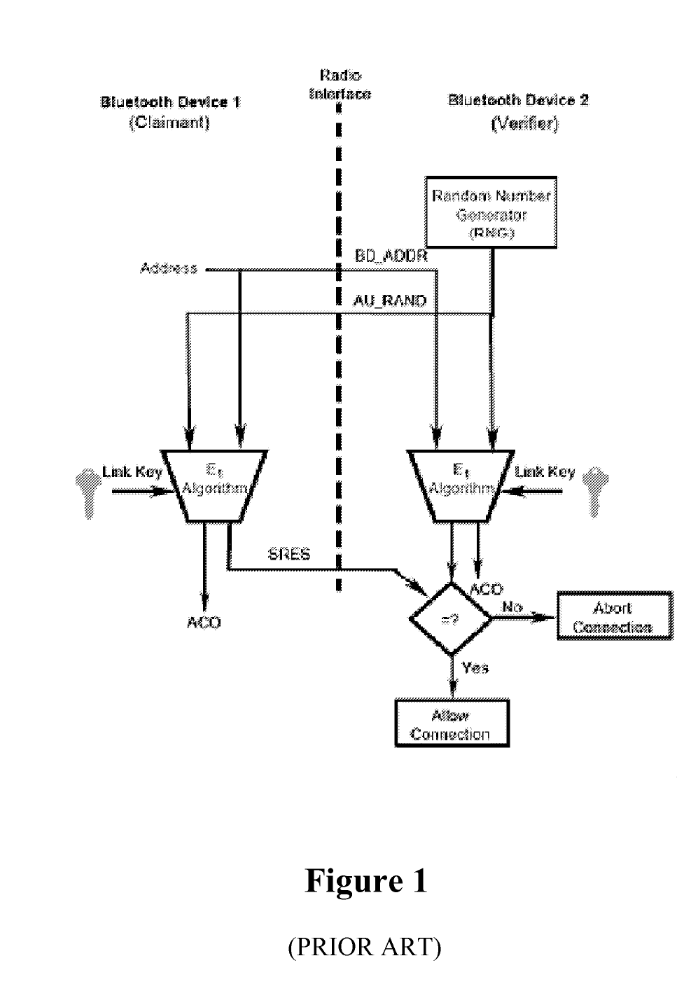

FIG. 2 conceptually illustrates one exemplary embodiment of a wireless communication system, in accordance with the present invention; and

FIG. 3 conceptually illustrates one exemplary embodiment of a method for establishing a secure short-range air interface between wireless communication devices using an intermediate core network, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

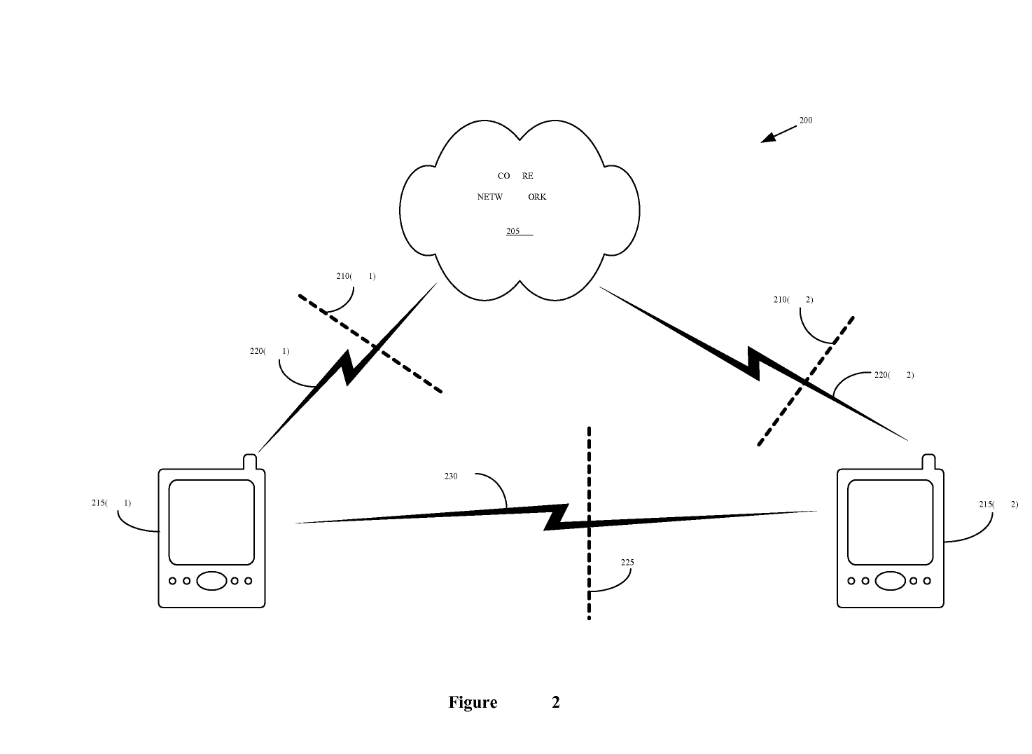

FIG. 2 conceptually illustrates one exemplary embodiment of a wireless communication system 200. In the illustrated embodiment, the wireless communication system 200 includes a core network 205, which may support one or more wireless communication interfaces 210(1-2). The indices (1-2) may be used to indicate individual wireless communication interfaces 210(1-2) or subsets thereof. However, the indices (1-2) may be dropped when the wireless communication interfaces 210 are referred to collectively. This convention may be applied to other elements depicted in the drawings. Although only two wireless communication interfaces 210 are depicted in FIG. 2, persons of ordinary skill in the art having benefit of the present disclosure should appreciate that the core network 205 may support any number of wireless communication interfaces 210.

The core network 205 supports communication over long-range air interfaces. Accordingly, the wireless communication interfaces 210 may be long-range air interfaces. Exemplary long-range air interfaces include, but are not limited to, the radiofrequency interfaces supported by the standards and/or protocols defined by one or more of the Universal Mobile Telecommunication System (UMTS), Code Division Multiple Access (CDMA, CDMA 2000), the Global System for Mobile communications (GSM), WiMAX, and the like. Long-range air interfaces are typically able to exchange signals over long distances. For example, a long-range air interface that operates according to UMTS standards and/or protocols may permit communication over distances of up to about 10 km. For another example, a long-range air interface that operates according to WiMAX standards and/or protocols may permit communication over distances in excess of 20 km.

The wireless communication system 200 includes two wireless communication devices 215. Exemplary wireless communication devices 215 include but are not limited to cellular telephones, personal data assistants, smart phones, text messaging devices, notebook computers, desktop computers, and the like. The wireless communication devices 215 may be configured to communicate with the core network 205 over the air interfaces 210. In one embodiment, the wireless communication devices 215 include one or more identity modules (not shown) that may be used to establish a wireless communication link 220 with the core network 205 over the long-range air interfaces 210. For example, wireless communication devices 215 that operate according to GSM include a Subscriber Identity Module (SIM) and wireless communication devices 215 that operate according to UMTS include a Universal Subscriber Identity Module (USIM). Techniques for establishing, maintaining, operating, and/or tearing down the wireless communication links 220 are known in the art and in the interest of clarity only those aspects of establishing, maintaining, operating, and/or tearing down the wireless communication links 220 that are relevant to the present invention will be discussed further herein.

The identity modules allow the wireless communication devices 215 and the core network 205 to implement security techniques such as authentication and encryption for information transmitted over the long-range air interfaces 210. In one embodiment, the wireless communication devices 215 and the core network 205 support the Authentication and Key Agreement (AKA) protocol for authenticating users and encrypting data transmitted over the air interfaces 210. The AKA protocols determine how various authentication and integrity keys are defined, provisioned, and verified, as well as how users and/or devices may be authenticated and/or mutually authenticated. However, persons of ordinary skill in the art having benefit of the present disclosure should appreciate that the present invention is not limited to air interfaces 210 that implement the AKA protocol and, in alternative embodiments, other security techniques may be used to authenticate users and/or encrypt data. Techniques for implementing security over the air interfaces 210 are known in the art and in the interest of clarity, only those aspects of the security techniques implemented by the air interfaces 210 that are relevant to the present invention will be discussed further herein.

The wireless communication devices 215 are also configured to support one or more short-range air interfaces 225. In one embodiment, the wireless communication devices 215 may be configured to establish a wireless communication link 230 over the short-range air interface 225 to exchange information between the wireless communication devices 215. For example, two personal data assistants 215 may exchange information over the wireless communication link 230 using a short-range air interface 225 that operates according to the Bluetooth protocols. For another example, a wireless earpiece 215 may establish a wireless communication link 230 over a short-range air interface 225 to exchange information with a cellular telephone 215. However, the present invention is not limited to Bluetooth short-range air interfaces 225. In alternative embodiments, other short-range air interfaces 225, such as interfaces defined by the IEEE 802 standards or protocols, may be implemented in the present invention. In one embodiment, the wireless communication devices 215 may maintain concurrent wireless communication links 220, 230 over the long-range air interfaces 210 and the short-range air interfaces 225.

The short-range air interfaces 225 are typically considered less secure than the long-range air interfaces 210. Conventional short-range air-interfaces 225, such a Bluetooth connection, are established without use of an identity module, such as the SIM and USIM modules that may be used to implement security techniques for communications over the long-range air-interface, as discussed above. For example, the short-range air interfaces 225 may not implement AKA protocols for authenticating the wireless communication devices 215 and/or encrypting data transmitted over the wireless communication link 230 using the short-range air interfaces 225. Furthermore, initialization and/or authorization sequences for conventional short-range air interfaces 225 are not exchanged outside the short-range air-interface, so that the short-range air interfaces 225 are more vulnerable to attackers than the long-rang air interfaces 210.

Accordingly, the security features of the long-range air interfaces 210 may be utilized to provide a secure communication channel between the wireless communication devices 215. The secure communication channel may then be used to establish a secure wireless communication link 230 over the air interface 225. In one embodiment, the wireless communication devices 215 establish a secure wireless connection that includes the wireless communication link 220(1), the core network 205, and the wireless communication link 220(2). The secure wireless communication link 230 may then be formed based on security information provided by the core network 205 using the secure wireless communication links 210.

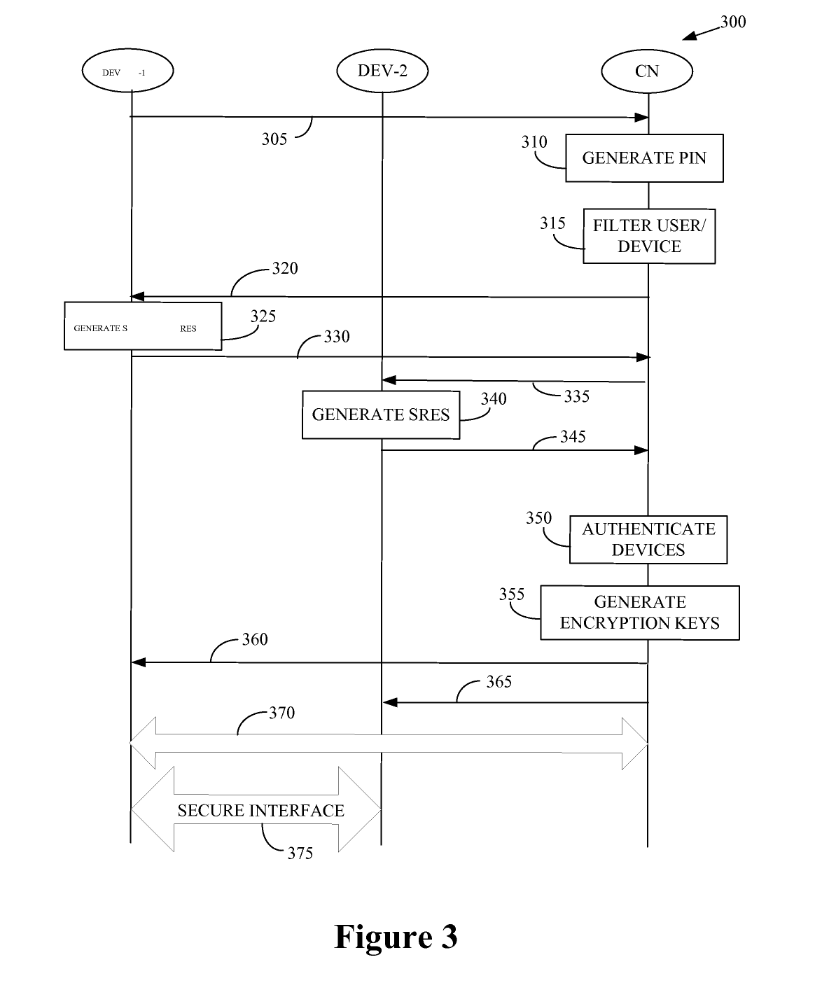

FIG. 3 conceptually illustrates one exemplary embodiment of a method 300 for establishing a secure short-range air interface between wireless communication devices (DEV-1, DEV-2) using an intermediate core network (CN). In the illustrated embodiment, the wireless communication devices are assumed to be able to support a long-range UMTS air interface with the core network and a short-range Bluetooth air interface with the other wireless communication device. However, as discussed above, the present invention is not limited to the UMTS and/or Bluetooth protocols and, in alternative embodiments, other long and/or short-range air interfaces may be implemented.

The method 300 begins when one of the devices (DEV-1 in the illustrated embodiment) provides a request to form a short-range air interface with the other device (DEV-2 in the illustrated embodiment), as indicated by the arrow 305. The request may be provided in any form, e.g., as a separate message, as a portion of an existing message, as signaling information, and the like. The request may be provided to the core network over the long-range air interface using data channels, access channels, signaling channels, and the like. In response to receiving the request, the core network may generate (at 310) a personal identification number (PIN) that may be associated with the device that provided the request and/or the device that will form the other endpoint of the short-range air interface. The PIN generated (at 310) may be longer than the typical 4-digit PIN selected by users and may therefore provide additional security relative to user-selected PINs. In one alternative embodiment, which may be practiced in addition to or in place of the aforementioned embodiments, an initial pairing of DEV-1 and DEV-2 may be established via the core network using PINs provided or suggested by the users of one or more of the devices.

In one embodiment, the core network may also filter (at 315) the user and/or one or more of the devices. For example, the core network may only permit short-range air interfaces to be established between known or preselected devices and/or users, such as devices and/or users within a group of trusted users and/or devices. Thus, the core network may only generate and/or provide a PIN to the known or preselected devices and/or users. In various embodiments, the core network may filter (at 315) the user and/or the devices based upon identifiers associated with or provided by the users and/or the devices. The PIN may only be generated (at 310) for users and/or devices that pass the filtering process implemented by the core network.

The PIN may then be provided to the requesting device over the long-range air interface, as indicated by the arrow 320. The requesting device may use the provided PIN to generate (at 325) one or more secure results (SRES) that can be used to verify and/or authenticate the requesting device. In the illustrated embodiment, the requesting device generates (at 325) the secure result using a pre-provisioned security key (e.g., a link key that is defined by the Bluetooth protocol and used to create the secure result), the provided PIN, and an encryption algorithm, such as the E₁ algorithm defined for the Bluetooth protocol. The secure result may then be provided to the core network over the long-range air interface, as indicated by the arrow 330. The PIN is also provided to the other device, as indicated by the arrow 335, which also generates (at 340) a secure result and provides (at 345) the secure result to the core network. Although FIG. 3 depicts the steps 320, 325, 330, 335, 340, 345 as occurring sequentially, persons of ordinary skill in the art having benefit of the present disclosure should appreciate that the steps do not need to be performed in the listed order. For example, the steps 320, 325, 330 may be performed concurrently with the steps 335, 340, 345.

The core network may then authenticate (at 350) the devices using the provided secure results. For example, the core network may compare the provided secure results and authenticate (at 350) the devices if the secure results are the same. The core network may not authenticate (at 350) the devices if the secure results differ, indicating that one or more of the devices does not possess the correct PIN, the correct link key, and/or the correct algorithm. If the core network authenticates (at 350) the devices, the core network may generate (at 355) one or more encryption keys, e.g., using the PIN, one or more sequence counters associated with the long-range air interface, one or more core network counters, and/or other information. The core network may provide the generated encryption keys to the devices, as indicated by the arrows 360, 365.

In one alternative embodiment, the core network may not generate the encryption keys and may instead provide (at 360, 365) information to the devices that may be used to generate the encryption keys. For example, the PIN, one or more sequence counters associated with the long-range air interface, one or more core network counters, and/or other information may be provided over the long-range air interface in response to authenticating (at 350) the devices. Copies of the encryption keys may then be provided to the core network over the long-range air interfaces. In one embodiment, the encryption information may also be exchanged periodically over the air interfaces as long as the devices remain authenticated to the core network.

The encryption keys may then be used to encrypt information that is exchanged via the long-range interfaces to establish a short-range air interface between the two devices, as indicated by the arrow 370. For example, the two devices may exchange information such as a device name, a device class, a list of services, technical information such as device features, manufacturer, Bluetooth specification, clock offsets, pass keys, Bluetooth profiles, and the like. In one embodiment, the encryption keys may also be used to secure information that the short-range air interface protocols indicate should be revealed upon demand. For example, Bluetooth devices should reveal on demand a 48-bit device name, a 24-bit device class, a list of provided services, clock offsets, device features, manufacturers, Bluetooth specifications, and the like. This information may be encrypted and provided over the long-range air interfaces.

A secure short-range air interface (indicated by the arrow 375) may then be established between the two devices. The trusted relationship between the two devices indicated by the secure short-range air interface 375 may be used in a hostile environment, such as an airport, or other heavily trafficked area. Since the information used to establish a secure relationship has been transmitted over the secure long-range air interfaces, the likelihood that an attacker can succeed in compromising the short-range air interface may be reduced relative to secure relationships that are formed using information transmitted over an initially unsecured short-range air interface between the two devices. In one alternative embodiment, devices that are already paired and do not need to be paired again, because they already have exchanged valid PINs, may be authenticated and the Bluetooth traffic may be redirected through the core network so that a secure connection is formed.

Embodiment of the techniques described above may improve mobile equipment security (relative to conventional techniques) by preventing fraudulent traffic from and to mobile phones over short-range air interfaces such as the Bluetooth interface. For example, the Bluetooth interface of a mobile unit may be hardened and made visible and accessible only to a trusted group of users and/or devices. In some embodiments, the implementation can be made backward-compatible with conventional techniques, e.g., by implementing default settings that support conventional (relatively insecure) Bluetooth interfaces. Since the security techniques described herein may be provided by the Internet service provider, users may not need to buy additional software protection products to secure their Bluetooth interface, i.e. through mobile firewalls, so mobile units may not suffer from early loss of battery-energy and loss of available processing-power because of the additional processing that may be required by these additional software protection products. In one embodiment, a hardware “read-only implementation” of one or more of the embodiments described herein may protect against malicious program code that is running on the mobile unit and trying to disable this protection.

Embodiment of the techniques described above may also support secure implementation of future features of short-range air interfaces such as Bluetooth. For example, the techniques described herein may be implemented in Atomic Encryption change, where encrypted links change their encryption keys periodically over a core network and may support simple and secure pairing over the core network. The techniques described herein may also be used to provide security for VoIP contexts, e.g., when Bluetooth may be used to support transmission and reception by cordless handsets. Base stations for VoIP typically need to be connected to the Internet, and so in this case the long-range air interface might also be embodied by a fixed line DSL internet connection, where the core network is located somewhere within the Internet. The techniques described herein may also offer protection against social engineering attacks like BlueBump because now only trusted (and therefore assumed non-malicious users as defined within the secure core net) are able to establish a connection of the short range air interface.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method involving a first device, at least one second device, and a core network in a wireless communication system, comprising:
establishing a first secure wireless connection over a first air interface between the first device and said at least one second device based on security information received from the core network using a second secure wireless connection over a second air interface.

2. The method of claim 1, comprising providing a request for the first wireless connection to the core network using the second secure wireless connection.

3. The method of claim 2, comprising receiving the security information from the core network in response to providing the request for the first wireless connection.

4. The method of claim 3, wherein receiving the security information comprises receiving a personal identification number generated by the core network.

5. The method of claim 1, comprising:
generating at least one security key based on the received security information;
providing said at least one security key to the core network; and
receiving at least one acknowledgment in response to the core network authenticating said at least one security key.

6. The method of claim 5, comprising forming at least one first encryption key based upon said at least one acknowledgment.

7. The method of claim 6, comprising providing said at least one first encryption key to the core network.

8. The method of claim 7, comprising receiving at least one second encryption key from the core network.

9. The method of claim 8, comprising communicating information using the first wireless connection, the information being encrypted and decrypted using at least one of the first and second encryption keys.

10. The method of claim 9, wherein communicating the encrypted information comprises communicating encrypted identifiers associated with at least one of the first and second devices.

11. A method involving a first device, at least one second device, and a core network in a wireless communication system, comprising:
providing security information to the first device, the security information being usable by the first device to establish a first secure wireless connection over a first air interface between the first device and said at least one second device, the security information being provided using a second secure wireless connection over a second air interface.

12. The method of claim 11, comprising receiving a request for the first secure wireless connection from the first device using the second secure wireless connection.

13. The method of claim 12, comprising providing the security information in response to receiving the request for the first wireless connection.

14. The method of claim 13, wherein providing the security information comprises:
generating a personal identification number in response to receiving the request for the first wireless connection; and
providing the personal identification number using the second secure wireless connection.

15. The method of claim 1, comprising:
receiving at least one security key from at least one of the first and second devices; and
providing at least one acknowledgment in response authenticating said at least one security key.

16. The method of claim 15, comprising:
receiving at least one encryption key from at least one of the first and second devices; and
providing said at least one encryption key to at least one of the first and second devices.

17. The method of claim 11, comprising:
determining whether at least one of the first and second devices are members of a selected group; and
providing the security information to the first device in response to determining that said at least one of the first and second devices are members of the selected group.
